(19) United States
(12) Patent Application Publication
(10) Pub. No.: US 2014/0372412 A1
(43) Pub. Date: Dec. 18, 2014

(54) DYNAMIC FILTERING SEARCH RESULTS USING AUGMENTED INDEXES

(71) Applicant: Microsoft Corporation, Redmond, WA (US)

(72) Inventors: MATTHEW G. HUMPHREY, ISSAQUAH, WA (US); MIKHAIL A. SIDOROV, BELLEVUE, WA (US); ZHENG WEI, BELLEVUE, WA (US)

(21) Appl. No.: 13/918,306

(22) Filed: Jun. 14, 2013

(51) Int. Cl. G06F 17/30

(52) U.S. Cl. CPC G06F 17/30979
USPC 707/722

(57) ABSTRACT

Methods and systems for using dynamic filtering for searching content items in augmented indexes are provided. A search query is received. The search query is associated with a sort attribute whose order is different from the implicit ordering of content items within the augmented indexes. A plurality of search query elements for the search query is identified. The plurality of search query elements includes the sort attribute having one or more attribute-range-elements each associated with an attribute-range of the sort attribute. An augmented index for searching the query elements is referenced. The augmented index comprises the one or more attribute-range-elements that map to one or more content items having an attribute-value in the attribute-range of the one or more attribute-range elements. Matching content items that satisfy the search query are identified based on selecting matching content items in the augmented index and dynamically filtering the matching content items into a matched-group using the one or more attribute-range-elements.

### BACKGROUND

Search engines utilize index data structures to perform user search queries for search results. Index data structures index documents in a single index order. A user may require that search results be returned quickly with the search results identifying the most relevant matching documents sorted in a different order. However, conventional index data structures and related algorithms fail to provide search engines with an index data structure that supports identifying the most relevant documents ordered based on an attribute different from the ordering of the documents within the index data structure. As such, the most relevant documents for a particular attribute sort order may not be returned, particularly in cases with a constrained time period for performing the search query.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the present invention provide a method and system for, among other things, using dynamic filtering to search content items associated with augmented indexes. This may be accomplished by receiving a search query. The search query includes instructions to sort the results by some attribute; the ordering of results by this attribute is different from the ordering of content items within the search index. A plurality of search query elements for the search query is identified. The plurality of search query elements includes the sort attribute having one or more attribute-range-elements each associated with an attribute-range of the sort attribute. An augmented index for searching the query elements is referenced. The augmented index comprises the one or more attribute-range-elements that map to one or more content items having an attribute-value in the attribute-range of the one or more attribute-range elements. Matching content items that satisfy the search query are identified. Identifying the matching content items comprises: selecting matching content items in the augmented index based on the plurality of search query elements determined for the search query; and dynamically filtering the matching content items into a matched-group using the one or more attribute-range-elements mapping to the matching content items. The matching content items of the search query are provided as search results.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary network environment in which embodiments of the invention may be employed;

FIG. 3 is a schematic diagram showing a method for using dynamic filtering to search content items associated with augmented indexes, in accordance with embodiments of the present invention;

FIG. 4 is a schematic diagram showing a method for using dynamic filtering to search content items associated with augmented indexes, in accordance with embodiments of the present invention;

FIG. 5 is a schematic diagram showing a method for using dynamic filtering to search content items associated with augmented indexes, in accordance with embodiments of the present invention;

FIG. 6 is a schematic diagram showing a method for using dynamic filtering to search content items associated with augmented indexes, in accordance with embodiments of the present invention;

FIG. 7 is a flow diagram showing a method for using dynamic filtering to search content items associated with augmented indexes, in accordance with embodiments of the present invention; and

FIG. 8 is a flow diagram showing a method for using dynamic filtering to search content items associated with augmented indexes, the content items in accordance with embodiments of the present invention.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising.” In addition, words such as “a” and “an,” unless otherwise indicated to the contrary, include the plural as well as the singular. Thus, for example, the requirement of “a feature” is satisfied where one or more features are present. Also, the term “or” includes the conjunctive, the disjunctive and both (a or b thus includes either a or b, as well as a and b).

For purposes of a detailed discussion below, embodiments of the present invention are described with reference to, for exemplary purposes, a search engine in the context of the searching for mobile device apps. Further, while embodiments of the present invention may generally refer to searching and the components described herein, it is understood that the techniques described may be extended to other implementations contexts performing the steps described herein.

In this description “content items” may refer to information retrieved based on keywords, queries, or their reformulations. The term “content items” is defined to include typical documents that are retrieved based on queries. More generally, content items include retrieved information resources and aids in identifying additional resources. Content items may be retrieved using an index data structure. Search engines maintain index data structures of content items that are matched to search queries in order to receive content items as search results.

Search engines are generally designed to search index data structures for search results relevant to a search query. Index data structures may include indexed documents i.e., sorted and/or ordered by some rank, for example, a static rank representing an approximation of the likelihood that the content item would be returned in a search query. This static rank may also be referred to as the index attribute or index ordering. A search engine may perform a search on an index data structure based on loose constraints and return a large number of search results (e.g., matching documents). Returning the matching documents may be optimized by implementing a time limit. The matching documents are identified in order of the index ordering, ranked by some unspecified algorithm, the top ranked documents selected and then re-ordered by this rank value, and then the documents are returned as search results; typically a user browses through only a handful of the matching documents in the search results. Further, if the search query requires ordering the matching documents based on a different attribute of the content items, search engines may first identify matching documents based on the index ordering and then separately sort based on the particular attribute to provide search results. With the time constraints imposed on search queries, not every matching document is examined and ranked. In this case, after sorting the partial results by the specified sort attribute, there may be visible missing results even in the top results that the user can be expected to see. To avoid this problem with traditional methods, all matching documents must be identified and retained prior to resorting by the attribute. This may lead to computationally expensive, slow searches.

In various embodiments, systems and methods are provided for searching content items using dynamic filtering. The systems and methods may allow for searching of content items in an index data structure. As discussed, the index data structure indexes the content items based on a single ordering on some attribute. The index data structure may be implemented as an inverted index with posting lists. Content items indexed in the index data structure may be associated with a sort attribute. The sort attribute is different from the index ordering of the index data structure; however search results may be efficiently returned based on the sort attribute in embodiments of the present invention. At a basic level, the sort attribute may have a range of attribute values identified for all content items. Multiple synthetic elements (e.g., attribute-range-elements) associated with different ranges (e.g., attribute-ranges) may be then be added into the inverted index. The synthetic elements map to content items that match the attribute-range based on a corresponding attribute value of the content item. Using dynamic filtering, content items are identified using the attribute-range-elements of the search query. In particular, dynamic filtering periodically updates the attribute-range-elements that are searched based on the search query attribute sort order and a target count of content items to be identified. In this regard, only the most relevant documents are identified for processing.

To further illustrate embodiments of the present invention by example, an index data structure may include content items (e.g., apps for a mobile device). Each content item may include several different attributes (e.g., popularity, title, rating, category, number of downloads, and price). An attribute may be an integer attribute, string, alphanumeric, or some other like formats. A user may search the content items to identify search results based on the Price, in ascending order. In this regard, a search query (e.g., “CARD GAME”—sorted based on ascending Price) may be received. It is contemplated that the search query may be received via an interface that provides a selection option for a sort attribute. The search query and any additional input may be parsed for query elements (e.g., search query terms). In particular, a sort attribute different from the index attribute of the search index is identified. As discussed below, the sort attribute is associated with synthetic elements i.e., one or more attribute-range-elements having an attribute-range of the sort attribute values of the content items. In embodiments, an expression of the search query may be reformulated to perform the search (e.g., [GAME]+[CARD]). The sort attribute may also be a reformulated query expression (e.g., [SORT]=[ASC]: [PRICE]).

Further, an augmented index (e.g., inverted index with synthetic elements in a posting list) of the content items may be utilized to execute the search query. The content items are partitioned into subsets of the Price (e.g., discrete groups Gᵢ). The partitioned content items are each associated with an attribute-range-element associated with an attribute-range. For example, the inverted index may include attribute-range-elements for Price values from $0-$MAX. The Price attribute may be associated with several different attribute-range-elements e.g., _group_{—}0 [$0 to $99] _group_{—}1 [$100 to $199] and _group_{—}2 [$200 to $MAX]. It is contemplated that the attribute-range-elements are inserted as additional posting lists into the inverted index. Other methods of associating the attribute-range-elements with the inverted index are contemplated within the scope of this invention. The entries in an attribute-range-element posting list map to all content items that have an attribute-value that corresponds to a value in the range of the attribute-range-element. For instance, _group_{—}0 [$0 to $99] entries map to all content items with Price values between $0 and $99. It is contemplated that the attribute-range-element of a content item may be tagged to the content item attribute.

In executing the search query i.e., identifying matching content items in the posting list, a matched content item is assigned to a matched-group using the one or more attribute-range-elements mapping to the matching content items during a process referred to as dynamic filtering. As such, embodiments of the present invention further dynamically filter content items into a matched-group based on the attribute-range-element during execution of the query. Content items that are identified for the search query are filtered using the attribute value of the content items that corresponds to the sort attribute of the search query. The attribute-range-elements in the index, each associated with an attribute range, facilitate this process with the mapping to the content items.

In operation, the dynamic filtering process may be associated with a target count. The target count designates how many content items should be identified. As content items are matched, the matched count is incremented. When the target count is reached, the inclusive range of attribute values encompassed by the content items matched so far is examined, and a determination is made to stop matching on attribute-range-elements that do not overlap this range. As such, more relevant documents are matched throughout the dynamic filtering process. This process of updating the attribute-range-elements that are included in the dynamic filtering process is repeated periodically as additional content items are matched, and over time the content items included in the dynamic filter converge towards an optimal set. This additional filtering may cause a significant reduction in the total number of documents matched by the query, and if that happens, the chances of the query timing out before retrieving all relevant matched documents is greatly reduced.

Accordingly, in a first aspect of the present invention, one or more computer-readable media storing computer-useable instructions that, when used by one or more computing devices, cause the one or more computing devices to perform a method for searching content items associated with augmented indexes, using dynamic filtering. The method includes receiving a search query, the search query is associated with a sort attribute. The method further includes identifying a plurality of search query elements for the search query, the plurality of search query elements includes the sort attribute having one or more attribute-range-elements each associated with an attribute-range of the sort attribute. The method also includes referencing an augmented index for searching the query elements, the augmented index comprises the one or more attribute-range-elements that map to one or more content items having an attribute-value in the attribute-range of the one or more attribute-range elements. The method further includes identifying matching content items that satisfy the search query; identifying the matching content items comprises: (a) selecting matching content items in the augmented index based on the plurality of search query elements determined for the search query; and (b) dynamically filtering the matching content items into a matched-group using the one or more attribute-range-elements mapping to the matching content items. The method also includes providing the matching content items of the search query as search results.

In a second aspect of the present invention, a system for searching content items associated with augmented indexes, using dynamic filtering. The system includes a query receiving component for receiving a search query, the query is associated with a sort attribute. The system also includes a parsing component for: identifying a plurality of search query elements for the search query, the plurality of search query elements includes the sort attribute having one or more attribute-range-elements each associated with an attribute-range of the sort attribute. The parsing component is also configured for: reformulating the search query with one or more syntax elements that support dynamic filtering. The system further includes a data store for storing the content items. The system also includes a query execution component for: referencing an augmented index for searching the query elements, the augmented index comprises the one or more attribute-range-elements that map to one or more content items having an attribute-value in the attribute-range of the one or more attribute-range-elements. The query execution component is also configured for: identifying matching content items that satisfy the search query based on selecting matching content items in the augmented index that are dynamically filtered into a matched-group based on the one or more attribute-range-elements mapping to the matching content items. The system also includes a presenting component for: providing for display the matching content items as search results.

In a third aspect of the present invention, one or more computer-readable media storing computer-useable instructions that, when used by one or more computing devices, cause the one or more computing devices to perform a method for searching content items associated with augmented indexes. The method includes receiving a search query; the search query is associated with a sort attribute, the sort attribute is different from an index attribute. The method also includes identifying a plurality of search query elements for the search query, the plurality of search query elements includes the sort attribute having one or more attribute-range-elements each associated with an attribute-range of the sort attribute. The method further includes reformulating the search query to include one or more syntax elements that support dynamic filtering. The method also includes referencing an augmented index for searching the query elements, the augmented index comprises the one or more attribute-range-elements that map to one or more content items having an attribute-value in the attribute-range of the one or more attribute-range-elements. Each of the attribute-range-elements is associated with an attribute-range based on predefined ranges derived from the attribute-values of the one or more content items. The method further includes identifying matching content items that satisfy the search query, identifying the matching content items comprises: (a) selecting matching content items in the augmented index based on the plurality of search query elements determined for the search query; and (b) dynamically filtering the matching content items into a matched-group using the one or more attribute-range-elements mapping to the matching content items. The method also includes providing a target count of matching content items from the matched-group as search results for the search query, wherein the matching content items in the target count are sorted based on the sort attribute.

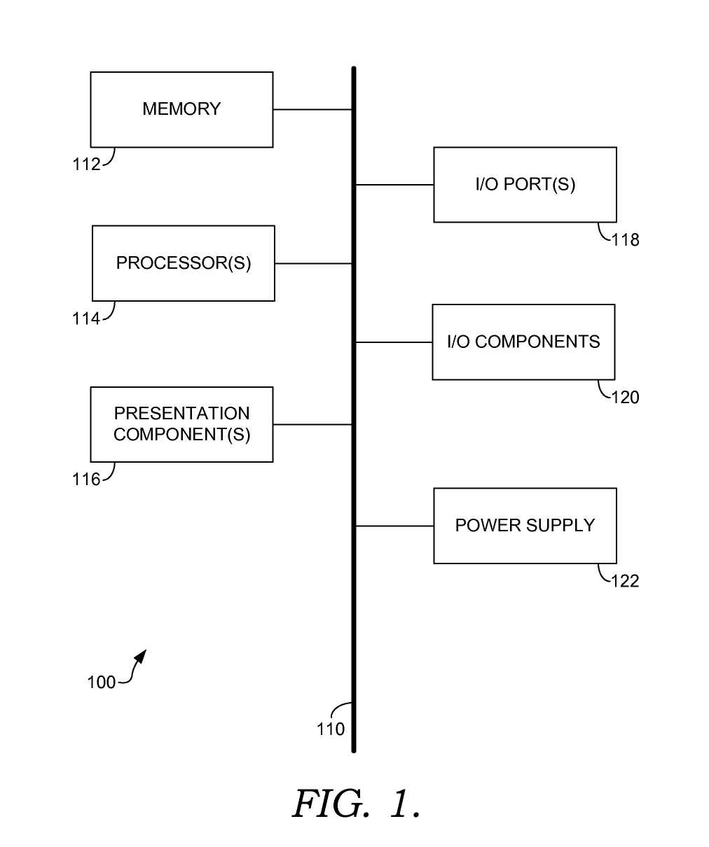

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

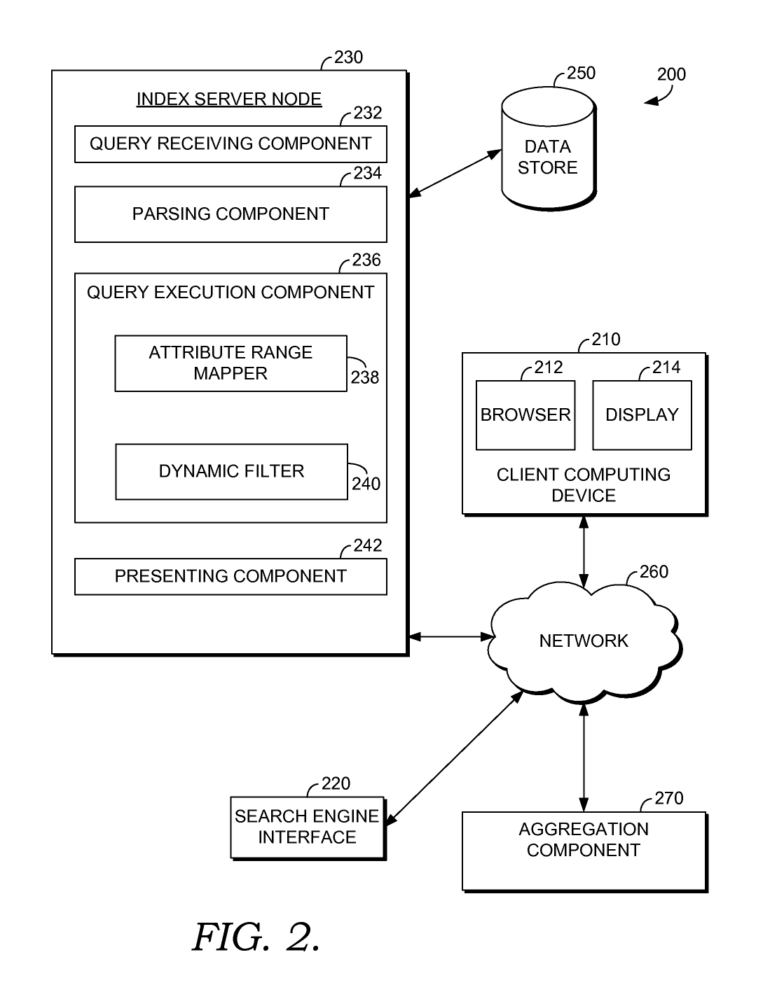

With additional reference to FIG. 2, a block diagram depicting an exemplary computing system 200 suitable for use in embodiments of the invention described. Generally, the computing system illustrates an environment in which content items may be identified using dynamic filtering. In particular, embodiments of the present invention provide systems and methods for dynamically searching based on an augmented index having synthetic elements that map to content items based on an attribute range associated with the synthetic element. Among other components not shown, the computing system 200 generally includes a client computing device 210, a search engine interface 220, an index server 230 and a data store 250, an aggregation component 270 all in communication with one another via a network 260. The network 260 may include, without limitation, one or more local area networks (LANs) and/or wide area networks (WANs). Such networking environments are commonplace in offices, enterprise-wide computer networks, intranets and the Internet. Accordingly, the network 260 is not further described herein.

In some embodiments, one or more of the illustrated components/modules may be implemented as stand-alone applications. In other embodiments, one or more of the illustrated components/modules may be implemented with the index server node 230, as an Internet-based service. Any number of client computing devices, search engine interfaces, index server nodes and search engine interface components may be employed in the computing system 200 within the scope of embodiments of the present invention. Each may comprise a single device/interface or multiple devices/interfaces cooperating in a distributed environment. For instance, the index server node 230 may comprise multiple devices and/or modules arranged in a distributed environment that collectively provide the functionality of the index server node 230 described herein. Additionally, other components/modules not shown also may be included within the computing system 200.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

With continued reference to FIG. 2, the client computing device 210 may include any type of computing device, such as the computing device 100 described with reference to FIG. 1, for example. Generally, the client computing device 210 includes a browser 212 and a display 214. The browser 212, among other things, is configured to render search engine home pages (or other online landing pages), and render search engine results pages (SERPs) in association with the display 214 of the client computing device 210. The browser 212 is further configured to receive user input of requests for various web pages (including search engine home pages), receive user input search queries (generally input via a user interface presented on the display 214 and permitting alpha-numeric and/or textual input into a designated search box) and to receive content for presentation on the display 214, for instance, from the index server node 230. It should be noted that the functionality described herein as being performed by the browser 212 may be performed by any other application capable of rendering content items. Any and all such variations, and any combination thereof, are contemplated to be within the scope of embodiments of the present invention.

The index server node 230 of FIG. 2 is configured to receive search queries, reference the index of content items, match received search queries to content items, and present content items that satisfy the search queries. As illustrated, the index server node 230 includes a query receiving component 232, a parsing component 234, a query execution component 236 having an attribute range mapper 238 and a dynamic filter 240, and a presenting component 242. The illustrated index server node 230 also has access to a data store 250. In embodiments, the data store 250 is configured to be searchable for one or more of the content items stored in association therewith. It will be understood and appreciated by those of ordinary skill in the art that the information stored in association with the data store 250 may be configurable and may include any information relevant to inverted indexes, search queries, attributes of content items, metadata, range mapping files, among other things. The content and volume of such information are not intended to limit the scope of embodiments of the present invention in any way. Further, though illustrated as a single, independent component, the data store 250 may, in fact, be a plurality of storage devices, for instance a database cluster, portions of which may reside in association with the index server node 230, the client computing device 210, another external computing device (not shown), and/or any combination thereof.

In embodiments, several different index server nodes (e.g., index server node 230) may support searching the content items in the data store 250 associated with the index server 230 node. In this regard, an embodiment of the present invention may include a plurality of index server nodes each associated with its own data store, where a search query is processed at the index server node for the portion of the content items within the data store 250 of the index server node. The portion of the content items may be searched via an index that may also be stored in the data store 250. The index server node 230 may further process a search query relative to the content items for that index server node 230. Thus index server node 230 may generate content items (e.g., search results) that are intended for aggregation with results from other similar search services as discussed later in more detail.

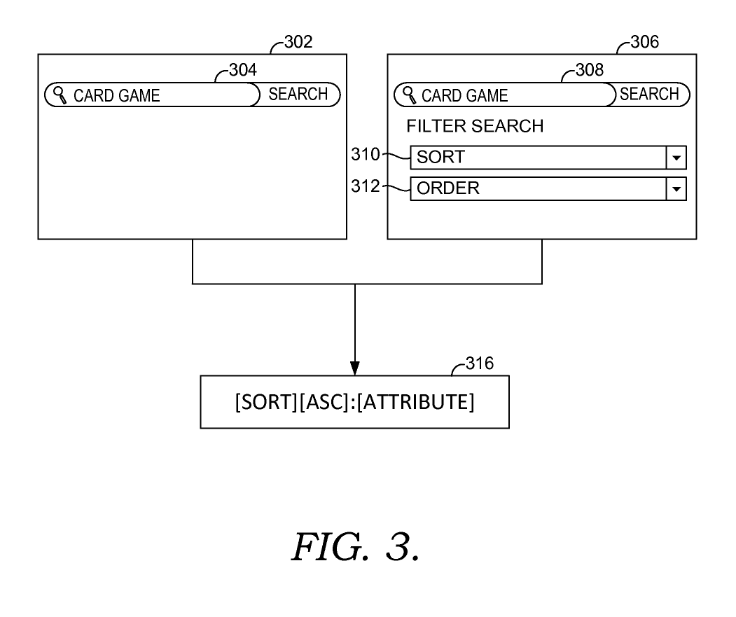

The query receiving component 232 of the index server node 230 is configured to receive requests for presentation of content items (e.g., algorithmically-identified search results) that satisfy an input search query. Typically, such a request is received via the browser 212, search engine interface 220, aggregation component 270, or combination thereof. For example, with reference to FIG. 3A, the search query may be received via a search interface 302 that provides a search input field 304, or received via a search interface 306 that provides a search input field 308. The search input interface 306 may further include search query elements as user interface selections. The search query elements, as discussed further below, may be used to further define the parameters of executing the search query based on user selected interface elements 310, 312, 314 (e.g., sort and order), among others. Several different types of interface elements are contemplated with embodiments of the present invention. In the case of search interface 302, search query elements may be inferred using a number of different factors. It should be noted, however, that embodiments of the present invention are not limited to users inputting a search query into a traditional query-input region of a screen display.

The parsing component 234 is configured to analyze and expand an expression of the search query for supporting dynamic filtering. The parsing component 234 may receive the search query with the additional search query elements that define the scope and structure of the search. For example, a user at the client computing device 210 may identify a sort attribute upon which a search query is performed and also provide the order (e.g., descending or ascending) in which the content items are presented. The search query elements selections may be identified explicitly through user interface elements on the computing device. Several different types of search query elements that are used to dynamically filter content items are contemplated with embodiments of the present invention. The parsing component 230 may also identify the search query elements based on implicit associations with the search query. A person of ordinary skill in the art may recognize several different methods of explicit and implicit search query elements based on a received search query.

In embodiments, the parsing component 230 may further provide syntax elements in the search query to form a reformulated expression that supports different aspects of the invention. The reformulated expression syntax may support, among other things, sorting and partitioning for dynamic filtering. The search query may be reformulated to include syntax elements for search query elements (e.g., sort attributes, search ordering, and ranges). With reference to FIG. 3, a search query reformulator 316 provides the format for the search query syntax elements (e.g., SORT=[ASC] [ATTRIBUTE]) for a received search query. Range syntax elements may also constrain the matched content items to just those meeting range criteria.

Further in embodiments, the reformulated expression syntax may include the path to the range mapping data structure that contains range mappings to attribute-range-elements as discussed in detail later. For example, a path (e.g., a file path) to the data structure may be implemented as a syntax element when executing the query. It is contemplated that parts of the syntax format may be optionally entered as required by the search. As shown, several types of syntax elements may be appended to the search query such that the query expression includes additional information for executing the query, and in particular dynamically filtering the identified content items. Any and all such information, and any combination thereof, is considered within the scope of embodiments of the present invention.

The query execution component 236 is configured to determine one or more matching content items relevant to the received query. The query execution component 236 includes the attribute range mapper 238 and the dynamic filter 240. The attribute range mapper 238 is configured to map attribute-values of the content items to specific attribute-range-elements. In embodiments, the attribute-range-element is included as an additional posting list within the inverted index and maps to each content item that has an attribute-value that corresponds to an attribute-value in the range of the attribute-range-element. Attribute range mapping occurs online while executing the search query. Attribute range mapping also occurs offline or online while indexing the content items. Range mapping may also occur by analyzing attribute values of the content items during index load time. Embodiments of the present invention may advantageously also use the attribute range mapper 238 to predefine ranges based on the attribute-value of content items in the index data structure. For example, the distribution of attribute-values, may determine how each range is defined. The predefined range may be defined in a data structure the include mappings of contiguous, distinct attribute-values to attribute-range-elements. The data structure may be implemented as a file, database, or other range mapping service. Any variations and combinations thereof may are contemplated with embodiments of the present invention. The data structure of mappings may provide a serialized representation of the predefined ranges. Content items having attribute-values defined in the data structure may be tagged accordingly, as such; during execution of the search query the tags facilitate dynamic filtering of the matched content items into a matched-group.

It is contemplated that the attribute range mapper 238 may use a secondary or tertiary key to be part of a sort when an attribute cluster exists where several different content items share the same attribute value. For example, the $0.00 to $0.99 price point may be a popular price point for mobile device apps, which then creates a cluster of contents items at that range. The secondary or tertiary key may be a unique key that facilitates further distinguishing the content items. As such, the content items are still returned in some deterministic and consistent order.

The dynamic filter 240 is generally responsible for identifying matching content items. The dynamic filter 240 assigns matching content items to a matched-group using the one or more attribute-range-elements mapping to the matching content items. As discussed, the attribute-range-elements map to one or more content items based on an attribute-value of the content item that corresponds to an attribute range of the attribute-range-element. The dynamic filter 240 may further be associated with a target count. The target count designates how many content items should be identified. The dynamic filter is configured to determine when to stop matching on attribute-range-elements (e.g., irrelevant attribute-range-elements) that do not overlap a range relevant to the search query based on reaching the target count. As discussed further below, excluding matching on irrelevant attribute-range-elements limits the matching to content items most relevant to the search query. The dynamic filter 240 may perform this function periodically as additional content items are matched.

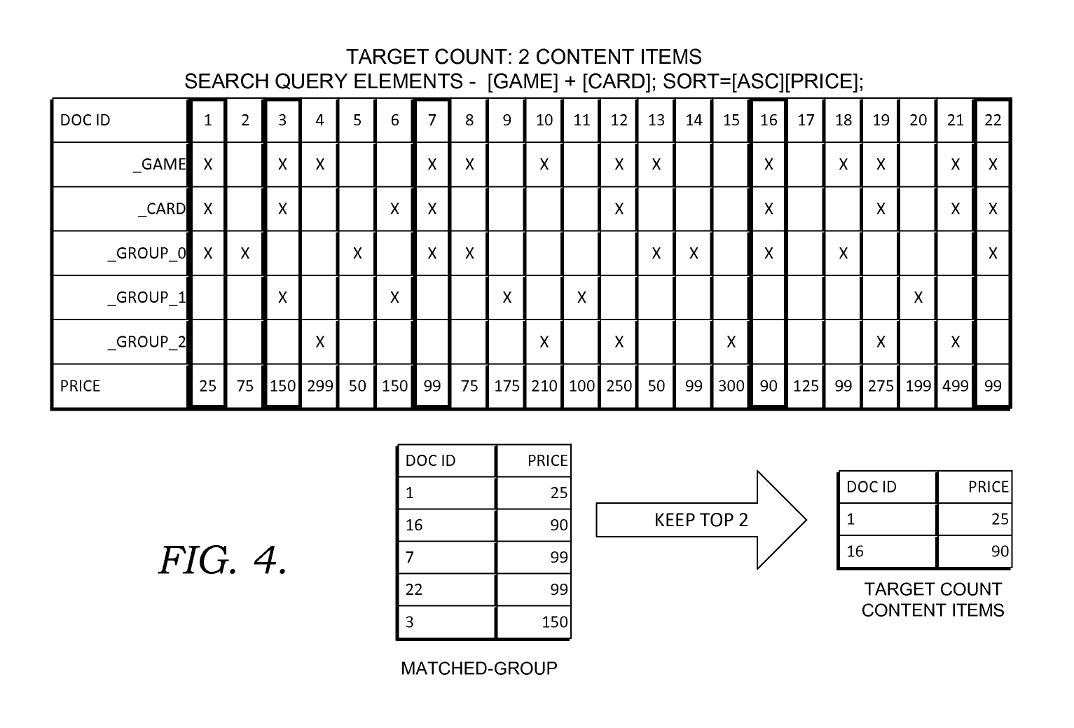

With reference to FIG. 4, a schematic diagram depicts an exemplary implementation of dynamic filtering. A search query ([GAME]+[CARD] SORT [ASC]:[PRICE]) is received. The search query includes instructions to sort the content items based on Price in ascending order; the ordering of content items is different from the index ordering. The search terms [GAME] and [CARD] may be referred to a search query elements. Search query elements may also include the attribute-range-elements for the PRICE attribute: (_GROUP_{—}0, _GROUP_{—}1, and GROUP_{—}2), each associated with an attribute-range ([$0 to $99], [$100 to $199], and [$200 to $MAX]) respectively. The cells to the right of the search query elements represent the posting list for each, where an ‘X’ in the cell indicates that the search query element has the content item in that column in its posting list. As mentioned, the dynamic filtering process may be associated with a target count. The target count designates how many content items should be identified.

In operation, the dynamic filter (e.g., dynamic filter 240) has all the attribute-range-elements. In FIG. 4, _GROUP_{—}0, _GROUP_{—}1, and GROUP_{—}2 are the attribute-range-elements for the Price attribute. The dynamic filter matches content items in the posting list of any of the attribute-range-elements. The dynamic filter initially matches content item—DOC ID #1. As shown content item—DOC ID #1 includes an ‘X’ in the search terms: [GAME] and [CARD] and the attribute-range-element _GROUP_{—}0. The content item—DOC ID #1 may be added into a matched-group as shown in FIG. 4. Next the dynamic filter matches content item—DOC ID #3. Similarly DOC ID #3 has cells indicating that the search query elements have the content item in their posting lists. At this point, however, the target count has been reached with DOC ID #1 and DOC ID #3 content items. The dynamic filter makes a determination to stop matching _GROUP_{—}2 attribute-range-element, focusing on _GROUP_{—}0 and GROUP_{—}1 to match more relevant content items during the dynamic filtering process. In this regard, _GROUP_{—}2 is an irrelevant attribute-range-element that may match content items not as relevant to the search query as the content items already matched or content items that may still be matched. Updating _GROUP_{—}0, _GROUP_{—}1, and GROUP_{—}2 to drop attribute-range-elements may be repeated periodically as additional content items are matched.

The dynamic filter further continues matching and matches content item—DOC ID #7 on the search terms and _GROUP_{—}0. The dynamic filter again makes a determination to drop _GROUP_{—}1 is from the further matching. _GROUP_{—}1 also is added to the set of irrelevant attribute-range-elements. Matching the content item continues with content item—DOC ID #16 of _GROUP _{—}0 and content item—DOC ID #22 of GROUP_{—}0. As shown in the matched-group, the dynamic filter technique progressively converged into the matched-group an optimal set of content items most relevant to the search query content items—DOC ID #1, 16, 7, 22, and 3 in contrast to matching all content items—DOC ID #1, 16, 7, 22, 3, 12, 19, and 21. The matched-group may be sorted and order by the sort attribute i.e., Price in ascending order. Content item—DOC ID #12, content item—DOC ID #19, and content item—DOC ID #21 each match on the search query elements; however these content items are excluded from processing because they all match on the irrelevant attribute-range-items _GROUP_{—}2 which was removed from processing. Thus, the dynamic filtering process resulted in a reduction in the total number of content items matched by the query, matching only on the most relevant content items, based on the sort attribute and order. In particular, instead of matching on 8 content items out of 22 (approximately 36%) with dynamic filtering the dynamic filter matched 5 content items out of 22 (approximately 23%). The addition of dynamic filtering, limits the number of content items that the index server ultimately matches. In search engines with many more groups and content items this translates to significant saving in costs. Further, the top two contents may be further communicated for additional processing, for example, in cases with more than one index node as discussed further below.

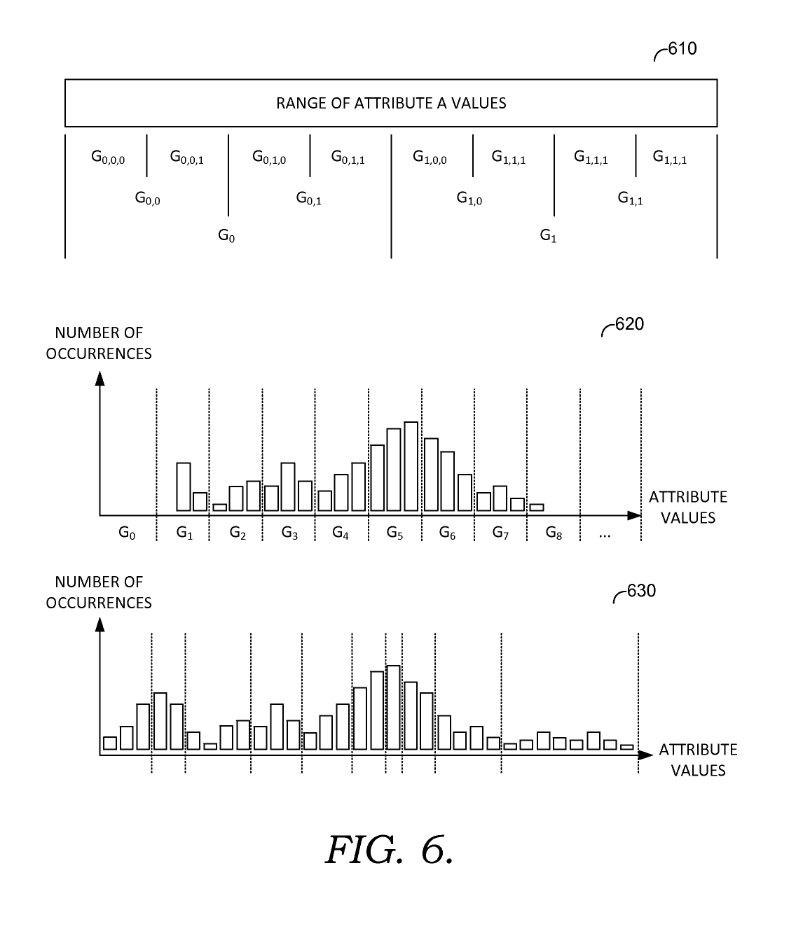

With reference to FIG. 6, the attribute range mapper 238 and the dynamic filter 240 may function together to provide mapping content items for improved performance. For example, attribute-ranges for the attribute-range-elements may be distributed based on a hierarchical structure 610 such that attribute-range sizes of the attribute-range-elements are not limited to simple linear assignment. A hierarchical structure may include overlapping attribute-range-elements of different sizes for more efficient dynamic filtering. In this regard, a hierarchy of attribute-ranges may be determined which may be combined to minimize the number of attribute-range-elements (and associated posting lists) that may be included in a particular phase of the dynamic filtering. Further, a basic linear distribution 620 of content items across a range attributes is possible but may not be optimum. In this example, G₅ has more content items that G₈ which may generate performance issues. As such, content item ranges may be created such that the count of content items in each range has a reduced variance (e.g., reduced variance distribution 630). The distribution of content items within ranges may be calculated offline to create a content item partition map. For each attribute, the map defines partitions of content items across attribute ranges. A search engine may load and cache these content item partition maps to be used in dynamic filtering when processing a search query.

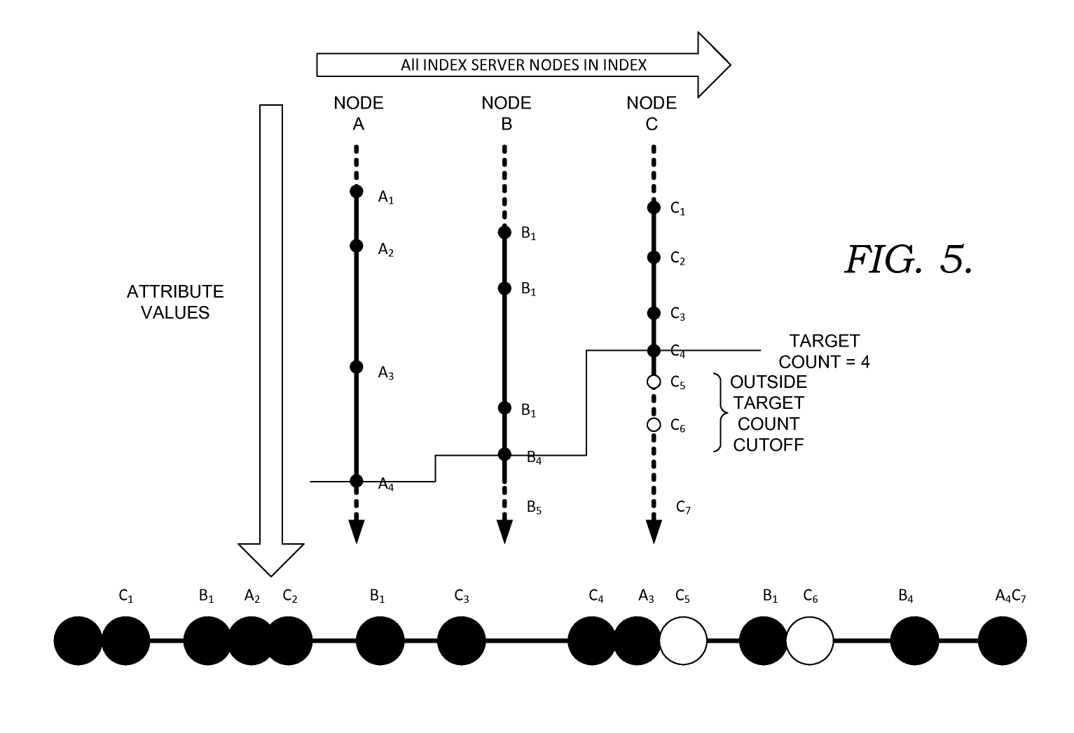

Turning to FIG. 2 and FIG. 5, the aggregation component 270 is configured to combine search results after a search query is executed. A search engine of the may operate on a search index that is too large for or otherwise impractical to host on a single computer. In those cases, the index may be split across multiple computers, each hosting an “index serving node”. In this regard, the aggregation component 270 may communicate a search query to a plurality of index server nodes and receive, from each, content items that satisfy the search query. The aggregation component may then combine and order the content items from each index server node, selecting the top items as the results for the search query.

It is further contemplated that the aggregation component 270 may also provide additional functionality to align content items across attribute ranges. Index server nodes may provide results that may not be aligned across attribute ranges and that result in missing values in the results. For, example, FIG. 5 shows results from 3 Index Server Nodes (NODE A, NODE B, and NODE C). Each node is associated with a target count of 4 content items. Each node may use a matching algorithm and the dynamic filtering steps defined herein to identify content items that satisfy the search query. In this example, because NODE C has a higher density of values near the start of the attribute range, the top 4 content items have a lower maximum attribute value than the other two nodes. However, two documents (C₅ and C₆) may be included in NODE C's results, but have lower attribute values than results included from NODE A and NODE B (A₄ and B₄). The aggregation component 270 may address this problem by assigning each index server node a higher target count such that the missing values in the final results become a statistically unlikely event. In other embodiments, the aggregation component 270 may also function to coordinate aggregation between results from the various index server nodes in that the aggregation component may reissue the query to the index server nodes with additional search criteria used to ensure a consistent range of attribute values across all nodes.

With continued reference to FIG. 2, the presenting component 238 is configured to transmit at least a portion of the matching content items as search results to the search query. The matching content items may be presented for display on the client computing device. The search results may be presented sorted by the sort attribute and further ordered either in descending or ascending order as prescribed in the search query. The search results may also be presented with user interface elements that identify and provide for interactivity with the one more attributes associated with the search results. Any and all such variations, and any combination thereof, are contemplated to be within the scope of embodiments of the present invention.

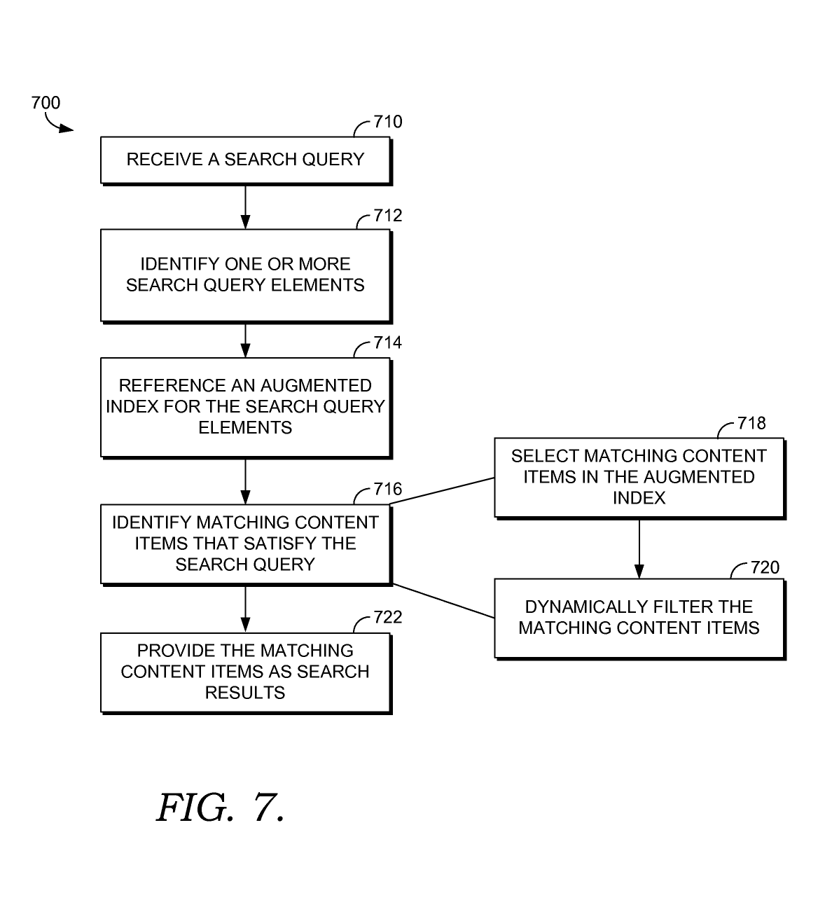

Turning now to FIG. 7, a flow diagram is provided that illustrates a method 700 for searching content items associated with augmented indexes, using dynamic filtering. At block 710, a search query is received. The search query is associated with a sort attribute. The sort attribute is different from an index attribute of the augmented index. The sort attribute is selected from a plurality of sort attributes associated with the content items. At block 712, a plurality of search elements for the search query is identified. The plurality of search query elements includes the sort attribute having one or more attribute-range-elements each associated with an attribute-range of the sort attribute. The one or more search query elements may be reformulated using syntax elements that support dynamic filtering. At block 714, an augmented index for searching the query elements is referenced. The augmented index comprises the one or more attribute-range-elements that map to one or more content items having an attribute-value in the attribute-range of the one or more attribute-range-elements. At block 716, matching content items that satisfy the search query are identified. Identifying the matching content items comprises: at block 718, selecting matching content items in the augmented index based on the plurality of search query elements determined for the search query; and at block 720, dynamically filtering the matching content items into a matched-group using the one or more attribute-range-elements mapping to the matching content items. At block 722, the matching content items of the search query are provided as search results.

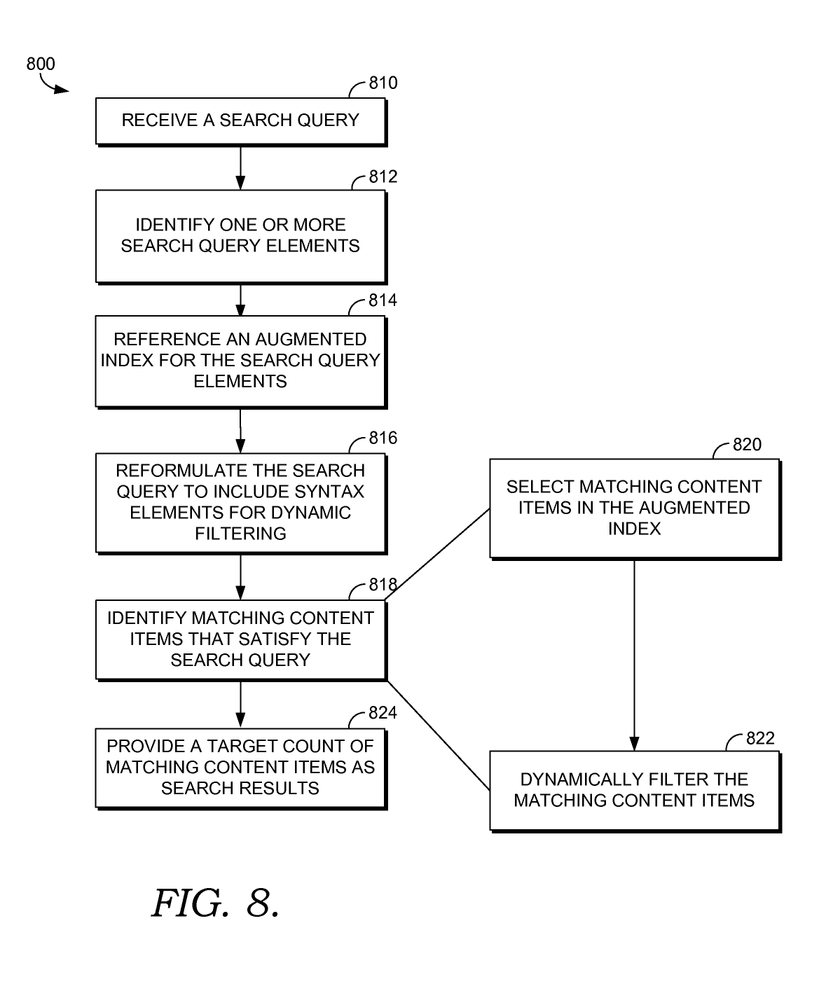

Turning now to FIG. 8, a flow diagram is provided that illustrates a method 800 for searching content items associated with augmented index, using dynamic filtering. At block 810, a search query is received. The search query is associated with a sort attribute; the sort attribute is different from an index attribute. At block 812, a plurality of search query elements for the search query are identified. The plurality of search query elements includes the sort attribute having one or more attribute-range-elements each associated with an attribute-range of the sort attribute and an ordering element for ordering matching content items of the search query. At block 814, an augmented index for searching the query element is referenced. The augmented index comprising the one or more attribute-range-elements map to one or more content items having an attribute-value in the attribute-range of the one or more attribute-range-elements. At block 816, the search query is reformulated to include one or more syntax elements that support dynamic filtering.

At block 818, matching content items that satisfy the search query are identified. Identifying the matching content items comprises: at block 820, selecting matching content items in the augmented index based on the plurality of search query elements determined for the search query. In embodiments, selecting matching content items further includes identifying the search query elements that are search query terms of the search query; identifying the search query elements that are attribute-range-elements of the search query, the attribute-range-elements associated with the sort attribute; and selecting matching content items based on an algorithm finding matching content items for both the search query terms and the attribute-range-elements.

Identifying the matching content items also comprises: at block 822, dynamically filtering the matching content items into a matched-group using the one or more attribute-range-elements mapping to the matching content items. In embodiments, dynamic filtering that matching content items further includes: identifying one or more excluded attribute-range-elements; and excluding one or more content items from dynamic filtering based on the excluded attribute-range-elements. At block 824 a target count of matching content items is provided as search results for the search query.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention in one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

The invention claimed is:

1. One or more computer-readable media storing computer-useable instructions that, when used by one or more computing devices, cause the one or more computing devices to perform a method for searching content items associated with augmented indexes, using dynamic filtering, the method comprising:
receiving a search query, wherein the search query is associated with a sort attribute;
identifying a plurality of search query elements for the search query, the plurality of search query elements includes the sort attribute having one or more attribute-range-elements each associated with an attribute-range of the sort attribute;
referencing an augmented index for searching the plurality of search query elements, wherein the augmented index comprises the one or more attribute-range-elements that map to one or more content items having an attribute-value in the attribute-range of the one or more attribute-range-elements;
identifying matching content items that satisfy the search query, wherein identifying the matching content items comprises:
(a) selecting matching content items in the augmented index based on the plurality of search query elements determined for the search query; and
(b) dynamically filtering the matching content items into a matched-group using the one or more attribute-range-elements mapping to the matching content items; and
providing the matching content items of the search query as search results.

2. The media of claim 1, wherein the sort attribute is different from an index attribute of the augmented index, the sort attribute is selected from a plurality of sort attributes associated with the one or more content items.

3. The media of claim 1, wherein the plurality of search query elements are determined based on an implicit association with the search query or an explicit association with the search query.

4. The media of claim 1, wherein the plurality of search query elements are associated with syntax elements that reformulate the search query to support dynamic filtering.

5. The media of claim 4, wherein the syntax elements provide a reformulation of the search query for at least one of the following:
the sort attribute;
a search attribute; and
an order feature.

6. The media of claim 1, wherein the augmented index is an inverted index comprising the one or more attribute-range-elements each represented with a posting list.

7. The media of claim 1, wherein the one or more attribute-range-elements are assigned the attribute-range based on predefined ranges derived from the attribute-value of each of the one or more content items.

8. The media of claim 1, wherein selecting matching content items in the augmented index based on the plurality of search query elements determined for the search query further comprises:
identifying the plurality of search query elements that are search query terms of the search query;
identifying the plurality of search query elements that are attribute-range-elements of the search query, the attribute-range-elements associated with the sort attribute; and
selecting matching content items based on an algorithm finding matching content items for both the search query terms and the attribute-range-elements.

9. The media of claim 1, wherein dynamically filtering the matching content items into the matched-group using the one or more attribute-range-elements mapping to the matching content items further comprises:
identifying a target count of matching content items;
upon the matching content items reaching the target count, selecting an irrelevant attribute-range-element to exclude from dynamic filtering; and
matching additional content items for the search query while excluding the one or more content items matching on the irrelevant attribute-range-element.

10. A system for searching content items associated with augmented indexes, using dynamic filtering, the system comprising:
a query receiving component for receiving a search query, wherein the search query is associated with a sort attribute;
a parsing component for:
identifying a plurality of search query elements for the search query, the plurality of search query elements includes the sort attribute having one or more attribute-range-elements each associated with an attribute-range of the sort attribute; and
reformulating the search query with one or more syntax elements that support dynamic filtering;
a query execution component for:
referencing an augmented index for searching the plurality of search query elements, wherein the augmented index comprises the one or more attribute-range-elements that map to one or more content items having an attribute-value in the attribute-range of the one or more attribute-range-elements; and
identifying matching content items that satisfy the search query based on selecting matching content items in the in the augmented index that are dynamically filtered into a matched group based on the one or more attribute-range-elements mapping to the matching content items; and
a presenting component for:
providing for display the matching content items as search results.

11. The system of claim 10, wherein the query execution component further comprises an attribute range mapper configured for:
mapping attribute-values of the one or more content items to the one or more attribute-range-elements, wherein mapping the attribute-value is performed offline or online; and
generating a unique key for further distinguishing a cluster of the content items that share attribute-values such that the content items are ordered based on the unique key.

12. The system of claim 10, wherein the query execution component further comprises dynamic filter configured for:
identifying a target count of matching content items;
upon the matching content items reaching the target count, selecting an irrelevant attribute-range-element to exclude from dynamic filtering; and
matching additional content items for the search query while excluding the one or more content items matching on the irrelevant attribute-range-element.

13. The system of claim 10, further comprising:
a plurality of index server nodes, each having at least the query receiving component, the parsing component, the data store, the query execution component, and the presenting component, wherein each of the plurality index server node is configured for:
receiving the search query, wherein the search query is distributed to each of the plurality of index server nodes;
processing the search query based a portion of the augmented index associated with each of the plurality of index server nodes; and
communicating the matching content items from each of the plurality of index server nodes for additional processing.

14. The system of claim 13, further comprising:
an aggregation component configured for:
distributing the search query to each of the plurality of index server nodes;
receiving the matching content items from each of the plurality of index server nodes; and
combining the matching content items from each of the plurality of index server nodes.

15. The system of claim 13, wherein combining the matching content items from each of the plurality of index server nodes, further comprises:
aligning matching content items across each of the attribute-range associated with the one or more attribute-range-elements.

16. One or more computer-readable media storing computer-useable instructions that, when used by one or more computing devices, cause the one or more computing devices to perform a method for searching content items associated with augmented indexes, using dynamic filtering, the method comprising:
receiving a search query, wherein the search query is associated with a sort attribute, the sort attribute is different from an index attribute;
identifying a plurality of search query elements for the search query, the plurality of search query elements includes the sort attribute having one or more attribute-range-elements each associated with an attribute-range of the sort attribute and an ordering element for ordering matching content items of the search query;
referencing an augmented index for searching the plurality of search query elements, wherein the augmented index comprises the one or more attribute-range-elements that map to one or more content items having an attribute-value in the attribute-range of the one or more attribute-range-elements;
reformulating the search query to include one or more syntax elements that support dynamic filtering;
identifying matching content items that satisfy the search query, wherein identifying the matching content items comprises:
(a) selecting matching content items in the augmented index based on the plurality of search query elements determined for the search query; and
(b) dynamically filtering the matching content items into a matched-group using the one or more attribute-range-elements mapping to the matching content items; and
providing a target count of matching content items from the matched-group as search results for the search query, wherein the matching content items of the target count are sorted based on the sort attribute and ordered based on the ordering element.

17. The media of claim 16, wherein each of the one or more attribute-range-elements is associated with the attribute-range based on predefined ranges derived from the attribute-value of the one or more content items.

18. The media of claim 16, wherein assigning predefined ranges to the matching content items comprises tagging the matching content items with an identifier of each of the predefined ranges.

19. The media of claim 16, wherein selecting matching content items in the augmented index based on the plurality of search query elements determined for the search query further comprises:
identifying the plurality of search query elements that are search query terms of the search query;
identifying the plurality of search query elements that are attribute-range-elements of the search query, the attribute-range-elements associated with the sort attribute; and
selecting matching content items based on an algorithm finding matching content items for both the search query terms and the attribute-range-elements.

20. The media of claim 16, wherein dynamically filtering the matching content items into the matched-group using the one or more attribute-range-elements mapping to the matching content items further comprises:
identifying the target count of matching content items;
upon the matching content items reaching the target count, selecting an irrelevant attribute-range-element to exclude from dynamic filtering; and
matching additional content items for the search query while excluding the one or more content items matching on the irrelevant attribute-range-element.
